(19) United States
(12) Patent Application Publication
(10) Pub. No.: US 2026/0359741 A1
(43) Pub. Date: Nov. 12, 2026

(54) COMPUTING SYSTEMS AND RELATED METHODS FOR FORECASTING UPTAKE OF VARIABLE RESOURCES

(71) Applicant: The Toronto-Dominion Bank, Toronto (CA)

(72) Inventors: Sheldon Lu-Ming TUNG, Markham (CA); Dhiren KAKKAR, Toronto (CA); Yu Ling IP, Markham (CA); Mouloud-Beallah BELBAHRI, Laval (CA); Jean-Christophe BOUËTTÉ, Montreal (CA); Leyi ZHANG, Toronto (CA); Mayank SHUKLA, Toronto (CA); Anna KESHABYAN-PRASAD, Maple Ridge (CA); Najma Mohamud OSMAN, Toronto (CA)

(21) Appl. No.: 19/204,810

(22) Filed: May 12, 2025

(51) Int. Cl. G06Q 10/0631; G06Q 10/04

(52) U.S. Cl. CPC G06Q 10/0631; G06Q 10/04

(57) ABSTRACT

Uptake forecasting systems and related methods are disclosed. The system includes a memory storing historical resource data and at least one processor operably coupled to the memory. The processor is configured to receive a query for a forecast relating to a set of variable resources and retrieve historical data related to the set of variable resources. The processor is further configured to, for each variable resource, apply historical data to an artificial intelligence resource model to predict resource amounts and apply the resource amounts to an artificial intelligence uptake model to predict uptake probabilities; divide the set of variable resources into one or more groups; for each group, select a predicted resource amount as the selected resource amount that maximizes a forecasted uptake of the set of variable resources; and for each variable resource, transmit the selected resource amount to at least one computing device for acceptance.

### FIELD

The described embodiments relate generally to computer-implemented systems and methods for forecasting uptake of variable resources.

### BACKGROUND

Many resources are available or offered based on complex terms. For example, some terms may include variable or term-limited availability. For example, commodities (e.g., oil, gas, electricity) and utilities (e.g., internet, mobile, cable. Such resources may include products and services that can depend on a multitude of factors including but not limited to, length of term, geographic area, service level or speed, volume, interest rates, cost of goods, foreign exchange rates, import tariffs, and the like. Further, these factors can fluctuate frequently. Accordingly, processing of such resources can be time intensive and time sensitive.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

The various embodiments described herein generally relate to systems for forecasting uptake of variable resources and related methods.

In accordance with an aspect of this disclosure, there is provided a computing system for forecasting uptake of variable resources. The system includes a memory and at least one processor operably coupled to the memory. The memory stores historical resource data. The at least one processor is configured to receive a query for a forecast relating to a set of variable resources and retrieve historical resource data related to the set of variable resources. The historical resource data for each variable resource includes a historical resource amount. The at least one processor is further configured to apply the historical resource data to an artificial intelligence resource model to predict resource amounts for each variable resource of the set of variable resources; apply the resource amounts to an artificial intelligence uptake model to predict uptake probabilities for each variable resource of the set of variable resources; divide the set of variable resources into one or more groups; for each group, select a predicted resource amount as a selected resource amount that maximizes a forecasted uptake of the set of variable resources; and for each variable resource of the set of variable resources, transmit the selected resource amount to at least one computing device for acceptance.

In some embodiments, the at least one processor can be configured to determine a sensitivity metric of the uptake probabilities with respect to the resource amounts; and the division of the set of variable resources into one or more groups based on the sensitivity metrics.

In some embodiments, a forecasted uptake of a variable resource can be a variable resource having an uptake probability greater than a pre-determined probability threshold.

In some embodiments, the pre-determined probability threshold can be configurable.

In some embodiments, the at least one processor can be configured to: determine a resource margin associated with each selected resource amount; compare the resource margin with a pre-determined margin threshold; and in response to determining that the resource margin is less than the pre-determined margin threshold, select another predicted resource amount for that variable resource.

In some embodiments, the query can include resource renewals within a pre-determined time period; and the at least one processor can be configured to identify one or more resources renewable within the pre-determined time period as the set of variable resources.

In some embodiments, the pre-determined time period can be either a six-month period, a four-month period, or a three-month period.

In some embodiments, the query can include initial resources; and the processor can be configured to identify one or more resources similar to the initial resources; and retrieve historical resource data of initial terms of the similar resources as the historical resource data related to the set of variable resources.

In some embodiments, the at least one processor can be configured to finalize an agreement in respect of the variable resource upon receipt of an acceptance of the variable resource from the at least one computing device.

In some embodiments, one or more of the artificial intelligence resource model can be a generalized propensity score model; or the artificial intelligence uptake model can be a casual curve model.

In accordance with another aspect of this disclosure, there is provided a computer-implemented method for forecasting uptake of variable resources. The method involves operating at least one processor to receive a query for a forecast relating to a set of variable resources; and retrieve, from memory, historical resource data related to the set of variable resources. The historical resource data for each variable resource can include a historical resource amount. The method further involves operating the at least one processor to apply the historical resource data to an artificial intelligence resource model to predict resource amounts for each variable resource of the set of variable resources; apply the resource amounts to an artificial intelligence uptake model to predict uptake probabilities for each variable resource of the set of variable resources; divide the set of variable resources into one or more groups based on the respective sensitivity metric; for each group, select a predicted resource amount as a selected resource amount that maximizes a forecasted uptake of the set of variable resources; and for each variable resource of the set of variable resources, transmit the selected resource amount to at least one computing device for acceptance.

In some embodiments, the method can involve operating the at least one processor to determine a sensitivity metric of the uptake probabilities with respect to the resource amounts, and divide the set of variable resources into one or more groups based on the sensitivity metrics.

In some embodiments, the method can involve operating the at least one processor to: determine a resource margin associated with each selected resource amount; compare the resource margin with a pre-determined margin threshold; and in response to determining that the resource margin is less than the pre-determined margin threshold, select another predicted resource amount for that variable resource.

In some embodiments, the query can include resource renewals within a pre-determined time period; and the method can involve operating the at least one processor to identify one or more resources renewable within the pre-determined time period as the set of variable resources.

In some embodiments, the query can include initial resources; and the method can involve operating the at least one processor to: identify one or more resources similar to the initial resources; and retrieve historical resource data of initial terms of the similar resources as the historical resource data related to the set of variable resources.

In some embodiments, the method can involve operating the at least one processor to finalize an agreement in respect of the variable resource upon receipt of an acceptance of the variable resource from the at least one computing device.

Other aspects and features will become apparent, to those ordinarily skilled in the art, upon review of the following description of some exemplary embodiments.

### BRIEF DESCRIPTION OF THE DRAWINGS

Several embodiments will now be described in detail with reference to the drawings, in which:

FIG. 1 is a schematic block diagram illustrating an example computing system, according to at least some embodiments;

FIG. 2 is a schematic block diagram illustrating an example computer, according to at least some embodiments; and

FIG. 3 is a flowchart of an example method of forecasting uptake of variable resources, according to at least some embodiments.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

Complex terms and fluctuating factors can result in various products and services being processed on an individual basis. That is, many products and services are processed in response to a client's request or inquiry. However, processing of such products and services individually, that is, on a case-by-case basis, can allow for bias from one or more of the factors to be introduced. Further, processing of such products and services can also be computationally or resource intensive, inefficient, and introduce delays in responding to the client's inquiry. Such delays can further reduce the likelihood of the client's uptake of the product or service.

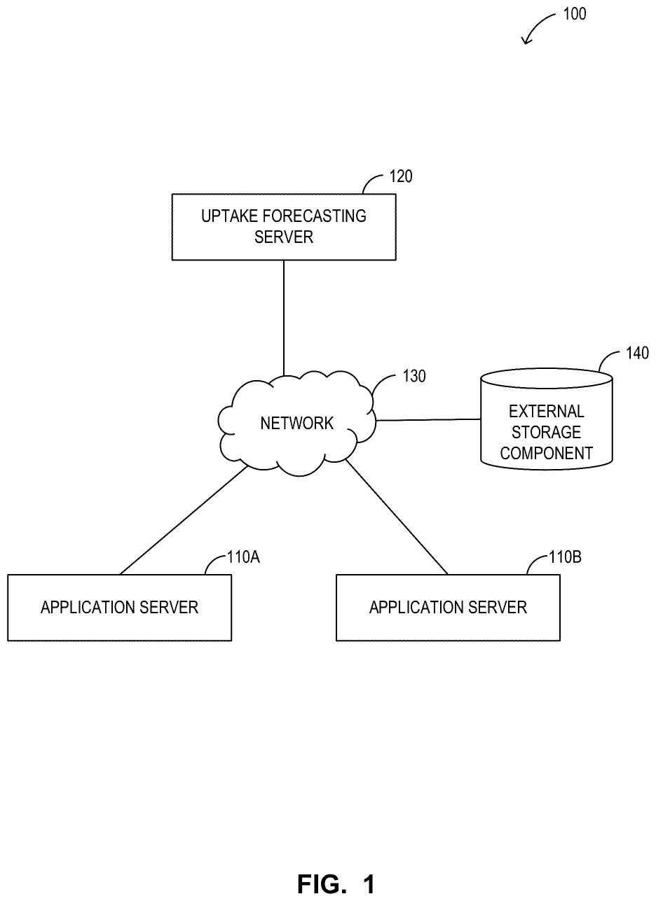

Referring now to FIG. 1, there is illustrated a schematic block diagram of an exemplary computing system 100, in accordance with at least some embodiments. Computing system 100 can include application servers 110a, 110b, (collectively referred to herein as application servers 110), an uptake forecasting server 120, a network 130, and an external storage component 140.

The application servers 110 and the uptake forecasting server 120 are computer servers that may be standalone computers, or nodes in a distributed or cloud-based computing system. Accordingly, application servers and the uptake forecasting server 120 are operatively coupled via network 130, which is a data communications network.

Application servers 110 can be configured to execute various tasks, such as but not limited to execution of resource models, generalized propensity score models, uptake models, casual curve models, segmentation algorithms, optimization algorithms etc. . . . For example, some application servers 110 can be web servers, other application servers 110 may form nodes in a distributed machine learning system, and so forth. Although two application servers 110 are shown in FIG. 1, the system can include fewer or more application servers.

Network 130 can include any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi®, WiMax®), Signalling System No. 7(SS7 ) network, fixed line, local area network, wide area network, and others, including any combination of these, capable of interfacing with, and enabling communication between the uptake forecasting server 120, the application servers 110 and/or the external storage component 140. Network 130 can include portions of public networks such as the Internet, other public or private networks, cloud systems, and/or other suitable data communication links.

External storage component 140 can include RAM, ROM, one or more hard drives, one or more flash drives or other suitable data storage elements such as disk drives. External storage component 140 can be provided by a database server, or servers, also operatively coupled via network 130. The external storage component 140 can store data in respect of the application servers 110 and/or the uptake forecasting server 120, including a historical resource database. Data can be stored in the external storage component 140 for subsequent retrieval by the application servers 110 and/or the uptake forecasting server 120.

The historical resource database can include data about historical resources. Data can include features of the resources, such as but not limited to a historical resource amount (e.g., historical price and currency), a historical term length (e.g., 1 year, 2 years, 3 years, 4 years, 5 years, 10 years etc., ongoing/indefinite length), a resource type, and other features (e.g., historical term start and end dates, historical volume or quantity, actual usage volume or quantity, interest rates). The resource type can relate to the type of resource or service. The variable resources can relate to but are not limited to commodities (e.g., oil, gas, electricity), services (e.g., internet, mobile, cable), and financial products, such as mortgages, personal loans, insurance, and guaranteed investment certificates. In the example of oil, the resource type can relate to different grades or sources. In the example of electricity, the type can relate to time-of-use (TOU) or tiered. In the example of internet and mobile, the type can relate to different technologies and speeds (e.g., DSL, fibre, LTE, 5G, and the like). In the example of a mortgage, the type can relate to an open or closed mortgage, or further an open fixed or open variable mortgage.

Although the external storage component 140 is described and shown as separate from the uptake forecasting server 120, other configurations are possible. In some embodiments, the external storage component 140 is hosted by the uptake forecasting server 120. In some embodiments, the external storage component 140 can be a third-party data storage.

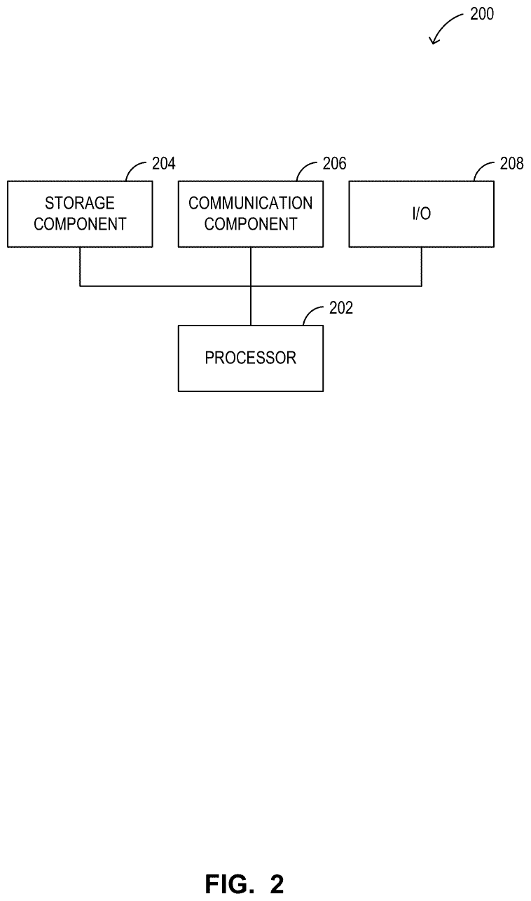

Referring now to FIG. 2, there is illustrated a schematic block diagram of an exemplary computer in accordance with at least some embodiments. Computer 200 is a generic example of a computer, such as the application servers 110 and/or the uptake forecasting server 120. Computer 200 generally has at least one processor 202 operatively coupled to at least one memory, or storage component 204, at least one communication component 206, and at least one additional input/output component 208.

The storage component 204, or memory, can include RAM, ROM, one or more hard drives, one or more flash drives or some other suitable data storage elements such as disk drives. For example, the storage component 204 can include volatile and non-volatile memory. Non-volatile memory can store computer programs consisting of computer-executable instructions, which can be loaded into the volatile memory for execution by the processor 202. Operating the processor 202 to carry out a function can involve executing instructions (e.g., a software program) that can be stored in the storage component 204 and/or transmitting or receiving inputs and outputs via the communication component 206. The storage component 204 can also store data input to, or output from, the processor 202, which can result from the course of executing the computer-executable instructions, for example.

The storage component 204 can store data received from a computing device, such as the application servers 110 or the uptake forecasting server 120. The storage component 204 can also store software applications executable by the processor 202 to facilitate communication between the uptake forecasting server 120 and the application servers 110, and configuration of the application servers 110 and the uptake forecasting server 120.

The storage component 204 can include one or more databases for storing data related to reference terms, expanded terms, and clarification prompts. The one or more databases can be provided by a database server, or servers. The one or more databases can be any type of database including, but not limited to a relational database, network database, object-oriented database, non-relational database or NoSQL database etc. In some cases, the one or more databases can be implemented in a conventional relational database management system (RDBMS), depending on the specific data being stored.

The processor 202 can control the operation of the computer 200. The processor 202 can include any suitable processors, controllers, digital signal processors, graphics processing units, application specific integrated circuits (ASICs), field programmable gate arrays (FPGAs), microcontrollers, and/or other suitably programmed or programmable logic circuits that can provide sufficient processing power depending on the configuration, purposes and requirements of the computer 200. In some embodiments, the processor 202 can include more than one processor with each processor being configured to perform different dedicated tasks.

The communication component 206 can include any interface that enables the computer 200 to communicate with various devices and other systems. For example, the communication component 206 can facilitate communication with the application servers 110, the uptake forecasting server 120, and the external storage component 140 via the communication network 130. Although only two application servers 110, one uptake forecasting server 120, and one external storage component 140 is shown in FIG. 1, the communication component 206 can facilitate communication with any number of application servers 110, query augmentation servers 120, and external storage components 140.

In some embodiments, the communication component 206 can include at least one of a serial port, a parallel port, or a USB port. The communication component 206 may also include a wireless transmitter, receiver, or transceiver for communicating with a wireless communications network, such as the communication network 130. The wireless communications network can include at least one of an Internet, Local Area Network (LAN), Ethernet, Firewire, modem, fiber, or digital subscriber line connection. Various combinations of these elements may be incorporated within the communication component 206.

In some embodiments, the input/output component 208 can include any device that enables the computer 200 to receive input data and/or provide output data. For example, the input/output component 208 can include at least one of various devices, such as a mouse, a keyboard, a touch screen, a thumbwheel, a trackpad, a trackball, a card-reader, voice recognition software, a display screen, a printer, a wireless radio, and the like depending on the requirements and implementation of the computer 200.

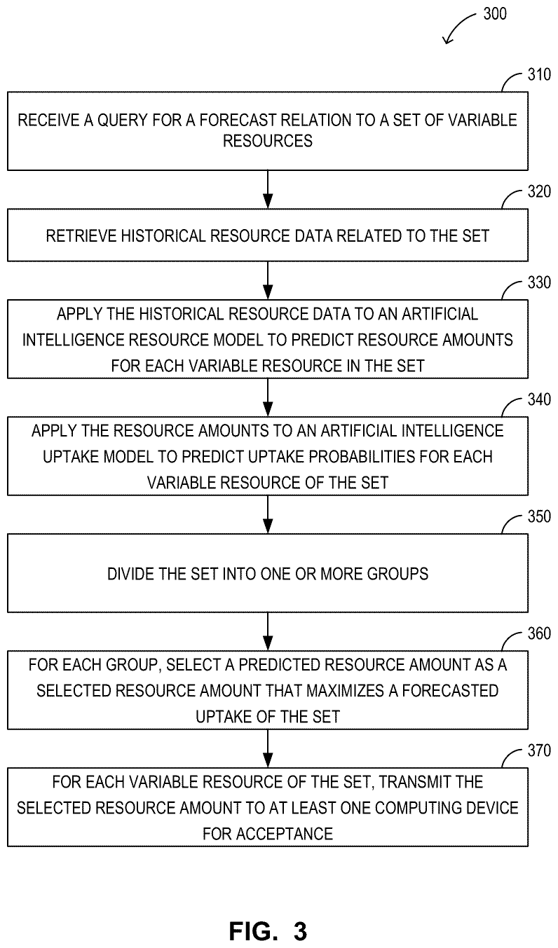

Referring now to FIG. 3, there is illustrated a flowchart diagram of an example method 300 for forecasting uptake of variable resources, in accordance with at least some embodiments. To assist with the description of method 300, reference will be made simultaneously to FIGS. 1 to 2. Method 300 can be carried out by a computer, such as uptake forecasting server 120 of FIG. 1.

Method 300 can begin at 310 when the uptake forecasting server 120 receives a query for a forecast relating to a set of variable resources. The query can be a query such as query. The query can be user-generated and received at an input/output component 208 from a computing device and transmitted to the uptake forecasting server 120. In some embodiments, the query is transmitted to the uptake forecasting server 120 via applications server 110.

The query can define a forecast or cohort population, that is, the set of variable resources and the time period to be forecasted. The query can define the set of variable resources by the features and type of resources. Each resource of the set of variable resources as referred to herein relates to a unique occurrence or transaction. That is, two variable resources of the set of variable resources can relate to the same commodity, product, or service, such as two service contracts.

The forecast query can relate to a renewal of the term-limited variable resource or an initial term of the term-limited variable resource. In some embodiments, the forecast query can relate to a forecast of an upcoming set of renewals within a pre-determined period. For example, the query can relate to a forecast of an upcoming set of renewals within a given start and end date, or four-month period from the date of the query, or other appropriate period. In another example, the pre-determined time period can be either a six-month period or a three-month period from the date of the query. The update forecasting server 120 can identify one or more resources, such as a cohort or a population of resources renewable within the pre-determined time period as the set of variable resources.

In some embodiments, the uptake forecasting server 120 can be pre-configured to carry out method 300 routinely, such a weekly or monthly basis without receipt of additional queries.

At 320, based on query, the uptake forecasting server 120 can retrieve historical resource data related to the forecast population from memory, such as external storage component 140 or storage component 204, storing a historical resource database. The historical resource data for each variable resource of the forecast population can include a historical resource amount.

For example, the historical resource database can store historical resource data about all previous mobile plans. The query can define the forecast resources to be DSL internet plans that are renewable in the fourth quarter of a given calendar year (e.g., Q4 2025). Accordingly, historical resource data stored in historical resource database relating to fiber internet plans can be omitted and not retrieved. Also, DSL internet plans stored in historical resource database that are renewable in the first to third quarters of the calendar year (e.g., Q1 to Q3 2025) can be omitted and not retrieved.

In some embodiments, the query can relate initial resources, in which no direct historical resource data is available. The update forecasting server 120 can identify one or more resources similar to the initial resources. The similarity can be based one or more features such as the type of resource, the resource volume (i.e., a quantity of the resource), the term of the product, buyer's profile, including geographic location, and the like. The update forecasting server 120 can retrieve historical resource data of initial terms of the similar resources as the historical resource data related to the set of variable resources.

At 330, the uptake forecasting server 120 can apply the historical resource data to a resource model, to predict resource amounts, such as a price or cost estimate, for each variable resource of the set of variable resources. That is, the uptake forecasting server 120 can apply the historical resource data for each variable resource in the forecast population to the resource model iteratively to generate a predicted resource amount for each product in the forecast population.

The resource model can generate a predicted resource amount based on the historical resource data for a resource. In some embodiments, the resource model can be implemented with artificial intelligence, such as but not limited to neural networks. The resource model can be a generalized propensity score (GPS) model. The GPS model can use linear regression with the historical resource amount as the target. The GPS model can be used as a balancing score to remove bias from the historical resource amount. The historical resource amount can include bias associated with differences in observed covariates. The GPS model can use features associated with the term-limited variable resources as confounders to predict the resource amount.

At 340, the uptake forecasting server 120 can apply the resource amounts to an uptake model to predict an uptake probability, or acceptance probability, for each variable resource of the set of variable resources. The uptake forecasting server 120 can apply the resource amount predicted at 330 for each variable resource in the forecast population to the uptake model iteratively to generate an uptake probability for each resource in the forecast population.

The uptake model can predict an uptake probability, or acceptance probability as a function of a resource amount. In some embodiments, the uptake model can be a casual curve model. In some embodiments, the uptake model can be a machine learning model trained based on historical resource data. In some embodiments, the uptake model can be implemented with artificial intelligence, such as casual AI.

At 350, the uptake forecasting server 120 can divide the set of variable resources into one or more groups. In some embodiments, the set of variable groups are segmented into groups based on a metric, such but not limited to sensitivity. For example, the uptake forecasting server 120 can group the forecast population into four groups: high sensitivity, moderate sensitivity, low sensitivity, and no sensitivity. Although four groups are described for illustration purposes, the uptake forecasting server 120 can divide the set of variable resources into the fewer or more groups.

The sensitivity metric can relate to the sensitivity of the uptake probability as a function of the resource amount. In some embodiments, the uptake forecasting server 120 can determine the sensitivity metric based on the uptake model. For example, the sensitivity metric can be the elasticity of the uptake probability with respect to the resource amount. The sensitivity metric can be related to other variables of the variable resource, such as but not limited to the term, rate, and the like.

At 360, the uptake forecasting server 120 can, for each group, select a predicted resource amount as a selected resource amount that maximizes a forecasted uptake of the set of variable resources. Maximizing the forecasted uptake can involve selecting resource amounts for each variable resource of the set that results in the greatest number of forecasted uptakes.

In some embodiments, the forecasted uptake of a variable resource is based on whether the uptake probability is greater than a pre-determined probability threshold. When the uptake probability is greater the pre-determined probability threshold, the variable resource can be considered a forecasted uptake. When the uptake probability is not greater than the pre-determined probability threshold, the variable resource can be considered a forecasted non-uptake. The pre-determined probability threshold can be configurable. The pre-determined probability threshold can be configured by a user. For example, a user can provide the pre-determined probability threshold in the query.

In some embodiments, the uptake forecasting server 120 can determine a resource margin associated with the selected resource amount for each group. The uptake forecasting server 120 can apply the selected resource amount to a margin model. The margin model can determine a resource margin as a function of a resource amount. In some embodiments, the margin model can be a machine learning model trained based on historical resource data.

The uptake forecasting server 120 can compare the resource margin with a pre-determined minimum margin threshold. If the resource margin greater than the pre-determined minimum margin threshold, the uptake forecasting server 120 can select the predicted resource amount as the selected resource amount for that variable resource.

If the resource margin is less than the pre-determined minimum margin threshold, the uptake forecasting server 120 can select another predicted resource amount for that variable resource. For example, the uptake forecasting server 120 can select a higher resource amount can be selected. Further, the uptake forecasting server 120 can select a higher resource amount that also has an uptake probability greater than the pre-determined probability threshold.

In some embodiments, the resource margin can be compared with a pre-determined maximum margin threshold. If the resource margin is greater than the pre-determined maximum margin threshold, the uptake forecasting server 120 can select a lower resource amount. Further, the uptake forecasting server 120 can select a lower resource amount that is also greater than the pre-determined minimum margin threshold and/or has an uptake probability greater than the pre-determined probability threshold. Each of the pre-determined minimum margin threshold and the pre-determined maximum margin threshold can be configured.

In some embodiments, when the resource margin does not meet the pre-determined minimum margin threshold or the pre-determined maximum margin threshold and the uptake forecasting server 120 selects another predicted resource amount, the uptake forecasting server 120 can select another predicted resource amount that also has a probability corresponding to a forecasted uptake.

At 370, the uptake forecasting server 120 can, for each variable resource of the set of variable resources, transmit the selected resource amount to at least one computing device for acceptance.

The uptake forecasting server 120 can transmit the selected resource amounts to respective computing devices for display. In some embodiments, the selected resource amount is transmitted to the same computing device from which the query was received. In this case, the set of variable resources is typically only one resource.

The computing devices to which the selected resource amounts are trans-mitted can be different from the computing device from which the query was received. For example, each selected resource amount can be transmitted to a computing device associated with a client for the variable resource. The client computing devices can receive user input indicative of acceptance of the variable resource at the selected price. The client computing device can transmit the acceptance to the uptake forecasting server 120. Upon receipt of acceptance from the client computing devices, the uptake forecasting server 120 can finalize an agreement in respect of the variable resource. Thus, by transmitting the selected resource amount directly to the client for the variable resource, the systems and methods disclosed herein can reduce delays in client acceptance and friction of acceptance, which can, in turn, increase the uptake probability.

Optionally, an acceptance of the variable resource can be received from the at least one computing device. Upon receipt of the acceptance, the update forecasting server 120 can finalize an agreement in respect of the variable resource. In some embodiments, the client acceptance data and selected resource amounts can be used for updating the update model used in 340.

Optionally, the uptake forecasting server 120 can update the forecast. For example, various factors can change since an initial forecast (generated via method 400), including but not limited to pre-determined margin thresholds, interest rates, and the like. In addition, one or more variable resources of the first forecast may have been accepted. The update forecasting server 120 can automatically generate an updated forecast with a set of the variable resources that have not been accepted yet after a pre-determined update time period. For example, the first forecast may be performed four months from a renewal date and an updated forecast can be generated two months after the first forecast (e.g., two months from the renewal date). The update forecasting server 120 can similarly transmit updated selected prices to the respective computing devices.

The systems and methods described herein provide an automated resource uptake forecast, including selection of resource amounts. The forecast for a set of resources, such as a forecast population, can streamline processing, and reduce or avoid the bias that can occur when resources are processed individually. Further, the system and methods can improve efficiency and reduce manual intervention typically required in processing resources, such an inquiry by a client and response thereafter, and follow-up or reminders.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive or. That is, “X and/or Y” is intended to mean X or Y or both, for example. As a further example, “X, Y, and/or Z” is intended to mean X or Y or Z or any combination thereof.

It should be noted that the term “coupled” used herein indicates that two elements can be directly coupled to one another or coupled to one another through one or more intermediate elements.

Unless the context requires otherwise, throughout the specification and claims which follow, the word “comprise” and variations thereof, such as, “comprises” and “comprising” are to be construed in an open, inclusive sense, that is, as “including, but not limited to.”

The embodiments of the systems and methods described herein may be implemented in hardware or software, or a combination of both. These embodiments may be implemented in computer programs executing on one or more programmable devices, each programmable device including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein. These devices may also have at least one input device (e.g. a pushbutton keyboard, mouse, touchscreen, or the like), and at least one output device (e.g. a display screen, a printer, a wireless radio, or the like) depending on the nature of the device.

Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system may be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by Apache Spark™ distributed, cluster-computing framework or a Databricks™ analytical platform. Further, and in addition to the CPUs described herein, the distributed computing components may also include one or more graphics processing units (GPUs) capable of processing thousands of operations (vector operations) in a single clock cycle, and additionally, or alternatively, one or more tensor processing units (TPUs) capable of processing hundreds of thousands of operations (e.g., matrix operations) in a single clock cycle.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high-level procedural or object oriented programming and/or scripting language, or both, to communicate with a computer system. Accordingly, the program code may be written in Python, Java, C++ or any other suitable programming language and may include modules or classes, as is known to those skilled in object-oriented programming. Alternatively, or in addition thereto, some of these elements implemented via software may be written in assembly language, machine language or firmware as needed. In any case, the language may be a compiled or interpreted language. Each such computer program may be stored on a storage media or a device (e.g., ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a non-transitory computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

1. A computing system for forecasting uptake of variable resources, the system comprising:
a memory storing historical resource data; and
at least one processor operably coupled to the memory, the at least one processor being configured to:
receive a query for a forecast relating to a set of variable resources;
retrieve historical resource data related to the set of variable resources, the historical resource data for each variable resource comprising a historical resource amount;
apply the historical resource data to an artificial intelligence resource model to predict resource amounts for each variable resource of the set of variable resources;
apply the resource amounts to an artificial intelligence uptake model to predict uptake probabilities for each variable resource of the set of variable resources;
divide the set of variable resources into one or more groups;
for each group, select a predicted resource amount as a selected resource amount that maximizes a forecasted uptake of the set of variable resources; and
for each variable resource of the set of variable resources, transmit the selected resource amount to at least one computing device for acceptance.

2. The system of claim 1, wherein the at least one processor is configured to:
determine a sensitivity metric of the uptake probabilities with respect to the resource amounts; and
divide the set of variable resources into one or more groups based on the sensitivity metrics.

3. The system of claim 1, wherein a forecasted uptake of a variable resource comprises a variable resource having an uptake probability greater than a pre-determined probability threshold.

4. The system of claim 3, wherein the pre-determined probability threshold is configurable.

5. The system of claim 1, wherein the at least one processor is configured to:
determine a resource margin associated with each selected resource amount;
compare the resource margin with a pre-determined margin threshold; and
in response to determining that the resource margin is less than the pre-determined margin threshold, select another predicted resource amount for that variable resource.

6. The system of claim 1, wherein:
the query comprises resource renewals within a pre-determined time period; and
the at least one processor is configured to identify one or more resources renewable within the pre-determined time period as the set of variable resources.

7. The system of claim 6, wherein the pre-determined time period comprises either a six-month period, a four-month period, or a three-month period.

8. The system of claim 1, wherein:
the query comprises initial resources; and
the at least one processor is configured to:
identify one or more resources similar to the initial resources; and
retrieve historical resource data of initial terms of the similar resources as the historical resource data related to the set of variable resources.

9. The system of claim 1, wherein the at least one processor is configured to finalize an agreement in respect of the variable resource upon receipt of an acceptance of the variable resource from the at least one computing device.

10. The system of claim 1, wherein one or more of:
the artificial intelligence resource model comprises a generalized propensity score model; or
the artificial intelligence uptake model comprises a casual curve model.

11. A computer-implemented method for forecasting uptake of variable resources, the method comprising operating at least one processor to:
receive a query for a forecast relating to a set of variable resources;
retrieve, from memory, historical resource data related to the set of variable resources, the historical resource data for each variable resource comprising a historical resource amount;
apply the historical resource data to an artificial intelligence resource model to predict resource amounts for each variable resource of the set of variable resources;
apply the resource amounts to an artificial intelligence uptake model to predict uptake probabilities for each variable resource of the set of variable resources;
divide the set of variable resources into one or more groups;
for each group, select a predicted resource amount as a selected resource amount that maximizes a forecasted uptake of the set of variable resources; and
for each variable resource of the set of variable resources, transmit the selected resource amount to at least one computing device for acceptance.

12. The method of claim 11, comprises operating the at least one processor to determine a sensitivity metric of the uptake probabilities with respect to the resource amounts, and divide the set of variable resources into one or more groups based on the sensitivity metrics.

13. The method of claim 11, wherein a forecasted uptake of a variable resource comprises a variable resource having an uptake probability greater than a pre-determined probability threshold.

14. The method of claim 13, wherein the pre-determined probability threshold is configurable.

15. The method of claim 11, comprises operating the at least one processor to:
determine a resource margin associated with each selected resource amount;
compare the resource margin with a pre-determined margin threshold; and
in response to determining that the resource margin is less than the pre-determined margin threshold, select another predicted resource amount for that variable resource.

16. The method of claim 11, wherein:
the query comprises resource renewals within a pre-determined time period; and
the method comprises operating the at least one processor to identify one or more resources renewable within the pre-determined time period as the set of variable resources.

17. The method of claim 16, wherein the pre-determined time period comprises either a six-month period, a four-month period, or a three-month period.

18. The method of claim 11, wherein:
the query comprises initial resources; and
the method comprises operating the at least one processor to:
identify one or more resources similar to the initial resources; and
retrieve historical resource data of initial terms of the similar resources as the historical resource data related to the set of variable resources.

19. The method of claim 18, comprises operating the at least one processor to finalize an agreement in respect of the variable resource upon receipt of an acceptance of the variable resource from the at least one computing device.

20. The method of claim 11, wherein one or more of:
the artificial intelligence resource model comprises a generalized propensity score model; or
the artificial intelligence uptake model comprises a casual curve model.
